(19) United States
(12) Patent Application Publication
(10) Pub. No.: US 2006/0085217 A1
(43) Pub. Date: Apr. 20, 2006

(54) Self-management system and method

(76) Inventor: Christopher J. Grace, Las Vegas, NV (US)

Correspondence Address: Christopher J. Grace, 11908 Love Orchid Lane, Las Vegas, NV, 89138, US

(21) Appl. No.: 11/250,930

(22) Filed: Oct. 14, 2005

Related U.S. Application Data
(60) Provisional application No. 60/619,057, filed on Oct. 14, 2004.

(51) Int. Cl. G06Q 99/00

(52) U.S. Cl. 705/1; 705/11; 705/8; 705/10

(57) ABSTRACT

According to the invention, a self-management system and method for organizing the key aspects of one's life is disclosed. The system and method include a core manager configured to allow central pooling of data and services that relate to common aspects of life. The system and method also include at least one peripheral manager configured to interrelate with the core manager and help an individual focus on one area of life. The data entered into the core manager is available while is using a peripheral manager and vice-versa.

This application claims priority based on U.S. Provisional Patent Application Ser. No. 60/619,057 entitled “Self Management System,” filed 14 Oct. 2004.

### 1. BACKGROUND OF THIS DISCLOSURE

The present invention relates to computer software and data management processes. One embodiment of the present invention further relates to the use of computer and/or internet based tools for managing specific areas of one's life such as relationships, career, personal finance, health, and hobbies in conjunction with tools to help an individual manage core information such as goals, scheduling, contacts, and/or assessments of overall emotion, philosophy, and ideology.

Prior to the present invention, there was no effective integrated data architecture or method that combined data used by core personal information management programs (such as Microsoft Outlook or the calendar/email/contacts/to-do list programs on a personal digital assistant) and peripheral programs and tools for managing things such as personal finance (e.g. Quicken by Intuit), health (e.g. diet, weight, or exercise tracking), career (e.g. training and education tools), relationships (e.g. dating software), or hobbies (e.g. photo software) to help individuals manage a broad spectrum of goals, tasks, contacts, and activities in their lives.

One embodiment of the present invention is based on the premise that life is about setting reasonable goals and going about achieving them. It is a life of focus, purpose, and achievement that brings happiness. Some goals are common to all people. Diet and fitness are key to an individuals well being. Financial stability and companionship are goals common to all as well. There is software to help people be successful in each of these vertical areas. Without these areas being integrated, there is no overview or linkages that help the user connect goals they've made with the steps that can be taken to carry them out. One embodiment of the present invention takes programs focused on disparate areas of life and ties them into goal management. It thereby brings to the forefront how the computer is a tool an individual can use to make his or her dreams come true.

Many of us have had the experience of caring for an ailing family member. Caring for the elderly and/or disabled is particularly challenging. Managing the doctor visits, prescriptions, meal preparation, appointments, and finances is incredibly complex. It is all too easy for caregivers to lose sight of their own lives and dreams. One embodiment of the present invention can be used to help those in this situation. Not only does it help with all the aforementioned areas of care giving, but also, it helps the caregiver to keep the rest of their own life's goals intact and in mind.

Students emerging from high school and college all too often have knowledge from their courses, but a complete lack of knowledge of what managing their own life entails. Before graduation their lives were managed for them. One embodiment of the present invention can help this situation. The self-management system channels the user into effective life management techniques such as goal setting, activity planning consistent with those goals, and organization. In addition, one embodiment of the present invention provides tools to increase success in many key areas the user sets goals in. For example a diet manager can increase the users success in maintaining a healthy diet. Using such a self-management system enables the user too intuit how to manage their lives without having been told explicitly. It is in these ways that using one embodiment of the present invention could help students in school while preparing them to be out on their own.

### 2. BRIEF DESCRIPTION OF THE DRAWINGS

The present disclosure is described in conjunction with the appended figures wherein:

FIG. 1 shows a self-management system;

FIG. 2 shows a data architecture for a self-management system;

FIG. 3 shows sample elements of a self-management system;

FIG. 4 shows a method for central data management in a core manager and peripheral manager;

FIG. 5 shows a generalized method for data management using core managers and peripheral managers;

FIG. 6 shows a sample core manager user interface;

FIG. 7 shows a sample peripheral manager user interface; and

FIG. 8 shows a method for building goals using a goal builder.

### 3. DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It should be understood that various changes may be made in the function and arrangement of elements without departing from the spirit and scope of the invention as set forth in the appended claims.

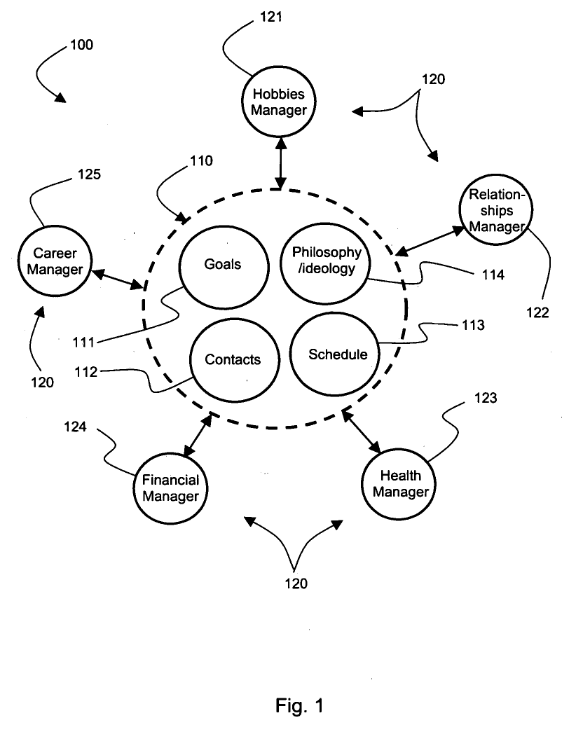

According to one embodiment of the present invention shown in FIG. 1, a self-management system 100 comprises one or more core modules, or core managers, 110 that allow central pooling of data and services for a number of peripheral modules, or peripheral managers 120. The peripheral managers 120 help individuals manage areas of life that help them live fully and happily (a full, happy life). Each peripheral manager 120 may comprise specialized modules, or specialized managers (not shown) for managing very specific areas of life or business, such as managing a transportation service. Virtually any program can be a peripheral manager 120, or a specialized manager, rather than just programs that deal with universal life issues. Advantageously, the present invention allows users to customize the managers to cover all areas of life, including family, business, work, school, church, projects, etc.

FIG. 1 illustrates an overall diagram 100 of one embodiment of the core managers 110 and peripheral managers 120 of the self-management system 100. The core managers 110 comprise at least one of a goals manager 111, a philosophy/ideology manager 114, a contacts manager 112, and a schedule manager 113. According to the self-management system 100, the core managers 110 allow for a central collection of data for the use of all peripheral managers 120. The peripheral managers 120 assist the individual in the management of several areas of daily life. The peripheral managers 120 may include, but are not limited to a career manager 125, a hobbies manager 121, a financial manager 124, a health manager 123, and a relationships manager 122.

In operation, using the goals manager 111 as an example, individuals set goals, which are stored in the goals manager 111. This is done through a particular user interface, which may be any type of interface capable of performing these functions, which is well known in the industry. That exact same interface can be accessed from within the goals manager 111 itself, or from within any manager of the peripheral managers 120.

For example, say the individual is working within the goals manager 111. The individual sets goals in a number of areas, such as to start playing soccer in a local league, or to increase income by twenty thousand dollars a year. Other goals are possible.

The goals are categorized according to preset categories, or customizable categories, such as those listed as peripheral managers 120 and discussed above, or by creating new categories. After the goals are entered and categorized, the individual can filter the goals to view the financial goals separately, or just the goals related to hobbies, etc. Just as goals can be categorized, so can items handled by other core managers, such as contacts and appointments. Any of these items can be filtered as well using methods well understood by those skilled in the art.

Core managers focus on areas that permeate multiple areas of life. For example, the goal manager 111 allows an individual to create and track goals. Goals are fundamental, and can be used with multiple peripheral managers, such as the financial manager and the diet manager.

A philosophy/ideology manager 114 can work somewhat differently. One embodiment of the ideology manager 114 includes an automatic thought module (not shown). Automatic thoughts are thoughts that quickly pop into one's head or flash by during the day. According to Cognitive Behavioral Psychology automatic thoughts are the basis of emotions. For example, while working on changing the starter in a car, an automatic thought might be “I'm a terrible mechanic.” In this case the emotion would be depression.

In one embodiment, the automatic thought manager is integrated into the core manager 110 because, like goals, contacts, and schedules, automatic thoughts may occur at any time and while working in any of the peripheral managers 120. Having automatic thoughts as a core manager 110 provides a shared interface allowing automatic thoughts to be worked with from any of the peripheral managers. Similarly, an automatic thought manager allows the individual to categorize the areas of life the thoughts are coming up in, for instance, while working out, thinking about diet, or working on finances. Similar to the goals, contacts, and schedules managers, the automatic thoughts can be filtered by the area of life to which they relate.

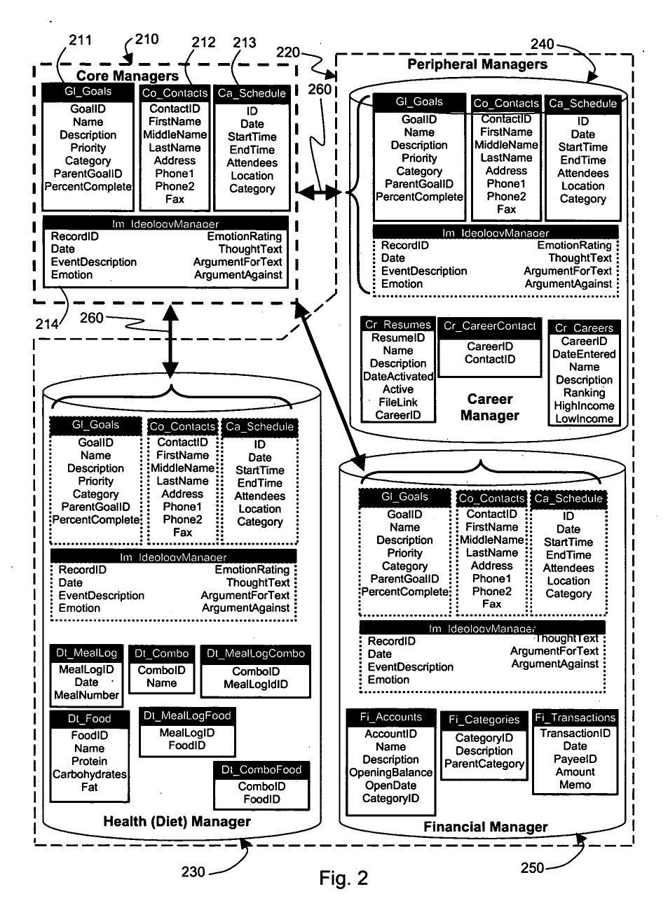

FIG. 2 depicts a self-management system data architecture that is consistent with one embodiment of the present invention. This data architecture includes core manager data tables 210 and peripheral manager data tables 220. Examples of core manager data tables can include a goals data table 211, a contacts data table 212, a schedule data table 213 for calendar-related items, and an ideology manager data table 214. In this example, the ideology manager has a set of data fields related to recording events, emotions, thoughts, and arguments that one would like to record. Examples of peripheral manager data tables are career manager data tables 240, diet manager data tables 230 (a type of health manager), and financial manager data tables 250. The peripheral manager data tables can include data tables that are specific to a peripheral manager. The peripheral managers can also have the capability of opening a central data interface 260 to access (e.g. view, add, edit, and delete) data entries in a core manager data table 210.

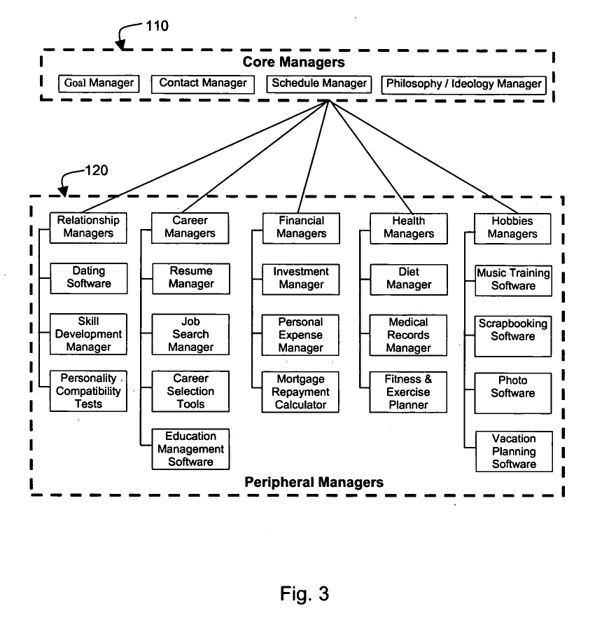

FIG. 3 shows sample elements of a self-management system that includes one or more core managers 110 and one or more peripheral managers 120. This diagram gives examples of the types of relationship managers, career managers, financial managers, health managers, and hobbies managers that may be part of a self-management system. In the prior art, these types of peripheral managers were not structured to share data with a core manager. In one embodiment of the present invention, at least one of these peripheral managers can share core data with a core manager through the use of a central data interface such as that depicted as 260 in FIG. 2.

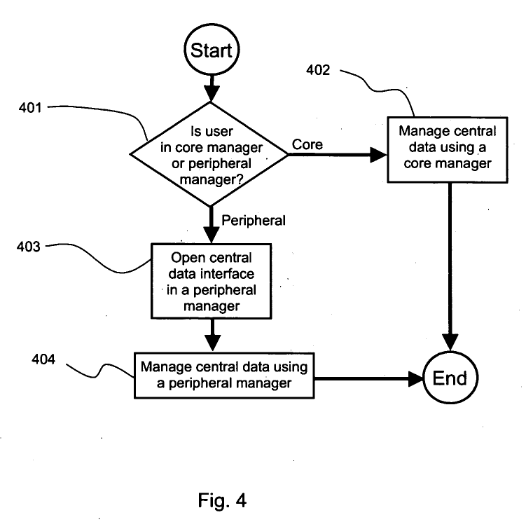

FIG. 4 shows a method of central data management in a core manager and peripheral manager. This process diagram also illustrates the shared nature of a core manager's interface. The process includes the step of checking whether a user is in a core manager or peripheral manager is active 401. If a user is in a core manager, the user can manage (e.g. view, create, edit, delete, etc) central data (e.g. goals, schedule, contacts, philosophy, and ideology, etc) in a core manager (goal manager, schedule manager, contact manager, philosophy/ideology manager, etc), a step shown at 402. If a user is in a peripheral manager, the user can accessing the same data by opening a central data interface in a peripheral manager, a step shown at 403, and then manage (e.g. view, create, edit, delete, etc) central data using a peripheral manager 120 in FIG. 1 or FIG. 3, a step shown at 404. Specific to the goal manager 111 in FIG. 1, graphs can be created to track the progress an individual is making toward reaching a goal. This is accomplished by generating units of measurement within that goal, according to its relationship with the peripheral managers 120 in FIG. 1 or FIG. 3. For example, the unit for a financial goal may be dollars. The unit of measurement for a health goal may be calories, or arm size, as defined by the user.

When creating or updating goals from within a peripheral manager 120 in FIG. 1 or FIG. 3, only core data such as goals, contacts, schedule, and ideology/philosophy related to that specific peripheral manager will be available for modification. For example, only goals related to hobbies will be shown to the user while the user is accessing the hobbies manager 121 in FIG. 1. From within the goal manager 111 in FIG. 1, the user can select to view all goals, or filter the goals by relationship to a peripheral manager 120 in FIG. 1 or FIG. 3.

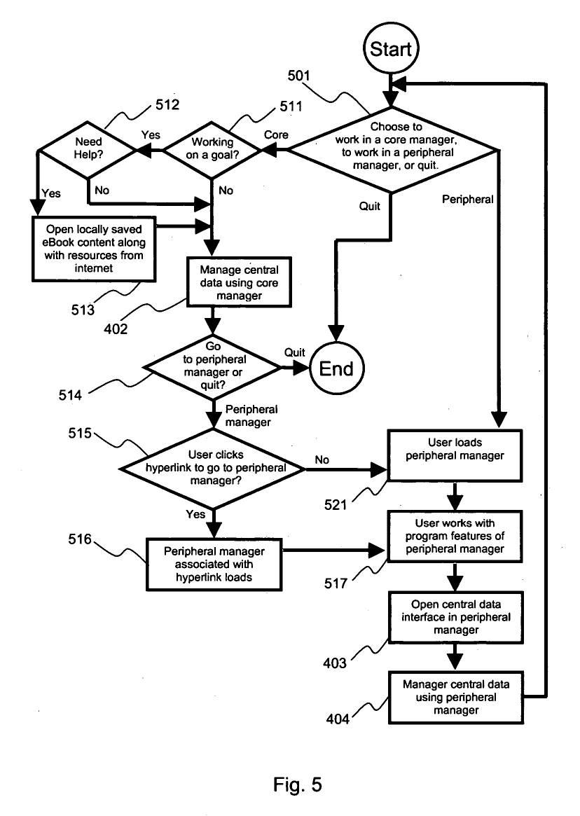

FIG. 5 shows a generalized method for data management using core managers and peripheral managers. The generalized method includes the same key functionality that was illustrated in FIG. 4:
the step of managing central data using a core manager 402;
the step of opening a central data interface in a peripheral manager; and
the step of managing central data using a peripheral manager.

FIG. 5 places the preceding three steps into a generalized framework. After starting, a user chooses whether to work in a core manager, to work in a peripheral manager, or to quit, a step shown at 501. If the user chooses to work in a peripheral manager, the next step is to load the peripheral manager 521 and then work with the program features of the peripheral manager 517. If a user is working in the peripheral manager wants to work on central data, the user opens a central data interface in the peripheral manager 403 and can then manage central data using the peripheral manager 404, without needing to open a core manager.

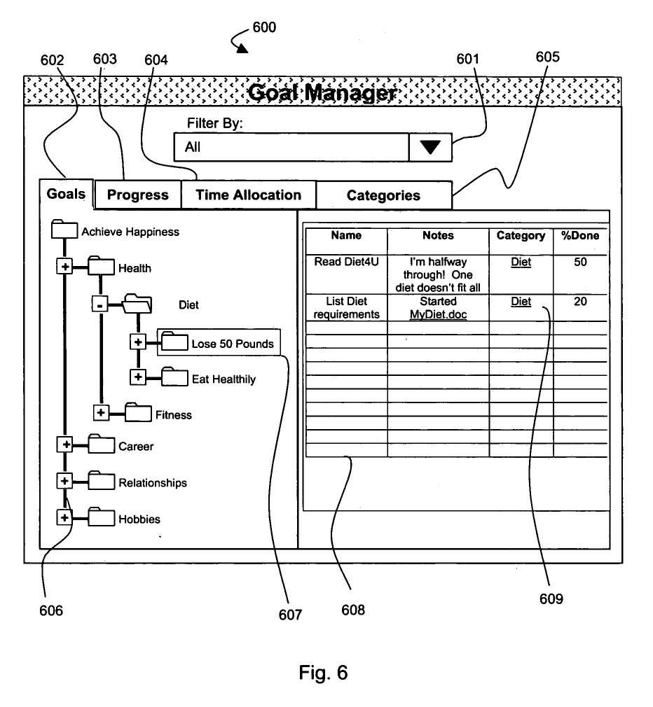

Further referring to FIG. 5, if the user chooses to work in a core manager, there may be differences in functionality depending upon which core manager is chosen. To address this, the embodiment shown here includes a decision box to branch if the user is working on a goal, a step shown at 511. If the user is working on a goal, the system gives the user the option to seek help, a step shown at 512, and can then provide this through things such as locally-saved eBook content or internet resources, a step shown at 513. Regardless of which of these branches are chosen, the user will have the ability to manager central data using the core manager, a step shown at 402 that is the same as the step described with regard to FIG. 4. Once a user has finished working on core data, the user can choose to go to a peripheral manager or quit, a step shown at 514. The user interface for a core manager (e.g. FIG. 6) may include one or more hyperlinks that allow a user. In that case, the user can click a hyperlink to go to a hyperlink, a step shown at 515. If there is no hyperlink, the process for loading a peripheral manager 521 is the same as described previously. If the user clicks a hyperlink to go to a peripheral manager, the peripheral manager associated with this hyperlink can load automatically, a step shown at 516, making it easier for the user to access and work with features of the peripheral manager 517. The use of a hyperlink avoids the user having to manually load a peripheral manager as depicted in step 521.

FIG. 6 shows a sample core manager user interface, 600. This is an example of an interface that a user might be working with when they are at step 402 in FIG. 4 or FIG. 5. This diagram shows a goal manager user interface. A schedule manager interface might show a calendar. A relations manager interface might show a list of names and their contact information. A philosophy/ideology manager might show a list of thoughts. The goal manager user interface illustrated here includes:
An interface to a filtering function 601 that allows the user to filter goals to work with one particular category;
A goals tab 602, that shows goals in a hierarchy and individual to-do items;
A progress tab, 603, that presents progress information in graphical form;
A time allocation tab, 604, that presents pie charts to illustrate how the user is allocating time amongst goals and contrasting that with the importance the user has assigned to each goal;
A categories tab, 605, that shows a list of categories with view/add/edit/delete capabilities that allows users to manage categories several layers deep;
A tree-view control, 606, that is add, edit, and delete capable and allows goals to be expanded to show sub-goals;
An indicator of which goal is currently selected, 607;
A list of to-do items for the selected goal, 608; and
A capability to link categories to peripheral managers, 609, that allow a user to open a linked peripheral manager by clicking on the link category 609.

The functionality depicted in FIG. 6 allows a user working in a goal manager to filter the view to show goals only in a certain category with a certain priority. Clicking the filtering function 601 drops down a list of items used to filter the view. The goals tab 602 shows goals and their sub-goals. Clicking on a goal 607 expands and contracts the goal to show or hide its sub-goals. Right clicking on folders allows the user to view/add/edit/delete items. Selecting an item 607 brings up a view of the lit of to-do items for that goal 608. By double-clicking on a selected item 607 the user can view a screen at allows editing of to-do properties including such things as priority and estimated time.

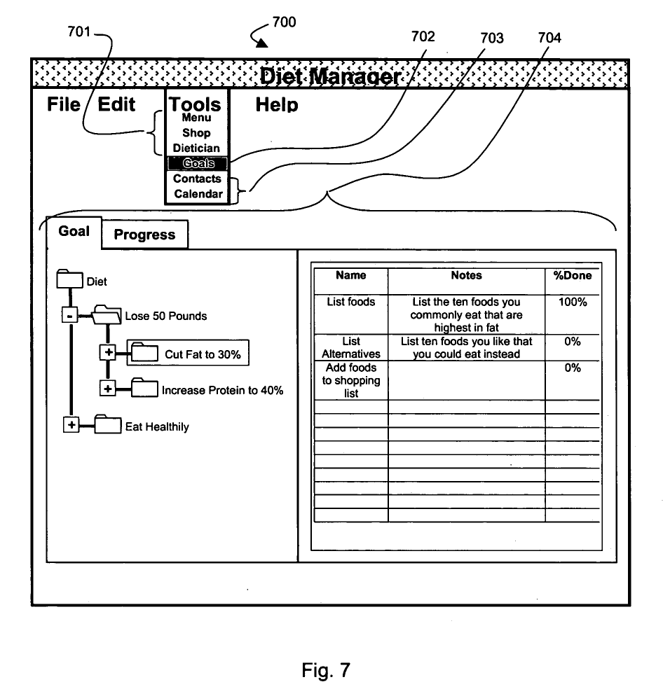

FIG. 7 shows a sample peripheral manager interface 700. This is an example of an interface that a user might be working with when they are at step 404 in FIG. 4 or FIG. 5. This diagram shows a diet manager user interface, as an example of type of health manager and shows the goals (core or central data) associated with this peripheral manager. A financial manager interface might show financial goals, schedule items related to personal finance, relationships related to personal finance, or thoughts/emotions/ideology/philosophy related to personal finance. Similar interfaces can be developed for career managers, hobbies managers, relationships managers, and other programs for specific (or peripheral) areas.

The diet manager user interface shown in FIG. 7 represents a diet management program similar to others in the market today such as Diet Master (which can be seen at http://www.lifestylestec.com). In one embodiment of the present invention, the user opens the diet manager and can start working with his or her diet. Clicking on the tools menu exposes several functions of the program that are unique to this particular peripheral manager 701, such as “Menu”, “Shop”, and “Dietician”. For example, if the user clicked on “Menu”, the diet manager could open a data grid showing hundreds of foods and their nutritional values. The user can then select foods and use these foods to build meals. As another example, if the user clicks on “Shop”, the user is taken to a a tool for building a shopping list that can be sorted for speedy shopping at the user's favorite store. The “Dietician” menu item allows the creation of meal reports to take to the user's dietician specialist. Integrated with these functions are the functions provided by core managers. For example, clicking on the “Goals” menu item 702, the central data interface in the peripheral manager, a step shown as 403 in FIG. 4 and FIG. 5, is invoked to generate a goal manager shared user interface 704. The peripheral manager interface 700 can also include interfaces to other core managers 703. These interfaces can work with central data in the same way as has been illustrated for the goal manager.

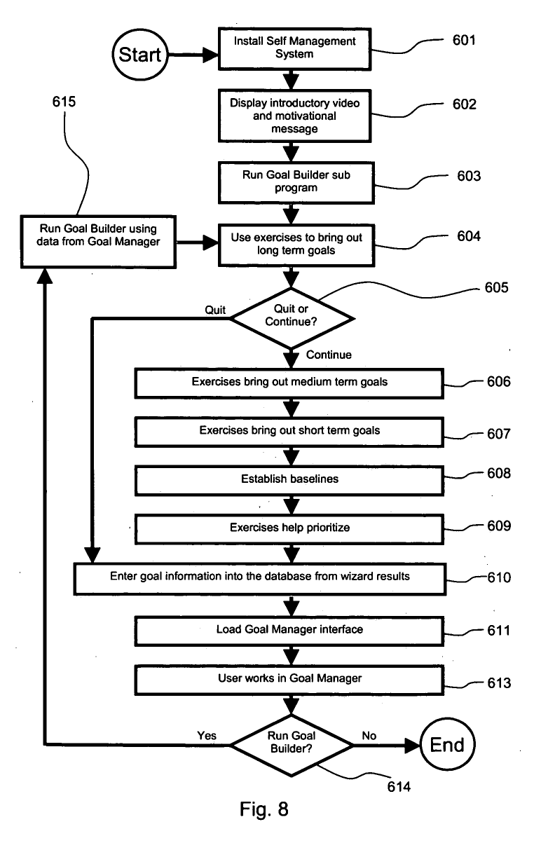

FIG. 8 depicts how an embodiment of the present invention can include a method for building goals using a goal builder. The process can include the following steps:
Installing a self-management system 601;
Displaying an introductory video and motivational message 602;
Running a goal builder subprogram 603;
Using exercises to bring out long-term goals 604;
Determining whether to quit or continue 605;
Using exercises to bring out medium-term goals 606;
Using exercises to bring out short-term goals 607;
Establishing baselines for each goal 608;
Using exercises to prioritize goals 609;
Entering goal information into a database using a wizard 610;
Loading a goal manager interface 611;
Working in a goal manager 613, is a step similar to step 402 in FIG. 4 and FIG. 5;
Deciding whether to run a goal builder 614; and
Running a goal builder 615.

The present invention can further include the following features:
Search for keywords in goals and automatically categorize the goal. Goal categories can be changed or applied manually. This information can be used to create a portal page on the internet for each user that links to additional resources for the achievement of user's goals. Since the problem of marketing is to show how your product solves a pressing problem in the prospects life. This portal is a way of making that link between a person's goals and available products and services.
Show a goal hierarchy graphic, and have it fade in and out emphasizing the associated goals when peripheral programs start.
The system can be used as an educational aid in classes teaching life management skills, such as special high school and college courses teaching young people how to manage their time and their lives. And for courses teaching home care givers how to manage caring for elderly relatives, foster children, and the developmentally disabled.
Each of the peripheral programs can be designed with a shell and plug-in architecture. This allows each peripheral to be co-branded, adapted and licensed to third party companies. One example application would be a company like 24 Hour Fitness that has a printed diet guide but no diet software. They could license the diet manager and save on development costs. The software could be branded with 24 hour fonts, colors and graphics. Special 24 hour meals and menus could be imported. Recommended balances of nutrients could be set in the software as optimal. But the infrastructure of the program including the part that lets people select meals, and view nutritional values can remain the same regardless of which company the software is branded to. Another example would be a health manager module that tracks medical conditions, prescriptions, doctors' appointments, and more. This software could be provided as part of a discount prescriptions program. The health manager's shell adopts the branding of the discount prescription company. The plug-in programs Order Now links on the medications to go to the discount prescription company website.

Each of the peripheral programs can be designed with a shell and plug-in architecture. This allows each peripheral to be co-branded, adapted and licensed to third party companies. One example application would be a company like 24 Hour Fitness that has a printed diet guide but no diet software. They could license the diet manager and save on development costs. The software could be branded with 24 hour fonts, colors and graphics. Special 24 hour meals and menus could be imported. Recommended balances of nutrients could be set in the software as optimal. But the infrastructure of the program including the part that lets people select meals, and view nutritional values can remain the same regardless of which company the software is branded to. Another example would be a health manager module that tracks medical conditions, prescriptions, doctors' appointments, and more. This software could be provided as part of a discount prescriptions program. The health manager's shell adopts the branding of the discount prescription company. The plug-in programs Order Now links on the medications to go to the discount prescription company website. The system can include the following shell and plug-in features:
A shell that can be altered to suit company by altering a configuration file and supplying related files such as logo images;
Program fonts, colors, splash screens, graphics, hyperlinks to web content, and diet advice in a help file that is customizable;
Algorithms to calculate special nutritional values relevant to a particular diet can be supplied which can be used to fill fields in the program reserved for diet specific information;
Custom algorithms to change predictions of diet results;
The ability for users to opt in to share info on their eating habits in a way where data gets uploaded electronically to the supplier and the user receives specially tailored offers;
The ability for users to import and export diet plans, diet logs, foods, and recipes;
The ability for users to set target values for nutritional values, weight, body fat %, cholesterol, and user defined items with graphs to how well these items match the user's goals; and
The ability to predict changes to weight and body fat % based on diet choices, activity levels, and past results.
Regardless of the shell and plug-in used, the program will tie in with the rest of the suite if the user has the whole suite installed, or act as a standalone program if the user does not.

The system architecture could further be structured so that each core manager has an interface that can be reused inside the interface of any of the peripheral managers. For example, if a user wanted to add a financial goal from within Financial manager, the user interface to do so would not have to be reprogrammed in the financial management program. The programmers would simple drop the goal manager control on the form in their programming environment. This gives the user a uniform way of adding goals, contacts, etc from any program in the suite. And the data the user enters is saved in the shared database.

Examples of functionality that can be included in a goal manager are:
Ability to record short, medium, and long term goals, and sub to-do items;
Ability to map daily to-dos, and each goal to the longer term goal, they are part of;
Ability to organize goals and to-dos hierarchically so the user can have sub goals and tasks as many levels deep as needed;
Ability to show all relationships graphically;
Ability to budget time to each goal;
Ability to graph time allotment;
Ability to provide a control for entering in and viewing to-dos that can be plugged in to other programs;
Ability to record a goal and to-do info in a database designed to be shared with other applications;
Support for multiple users with shared rights management capabilities;
Ability to assign goals and tasks to a user; and
Ability to view other users' progress and status.

Examples of functionality that can be included in a contacts manager are:
Ability to integrate with most other programs in the suite;
Ability to add/edit/view/delete appropriate contacts for each other program; and
Ability to use a shared control like in was described for the goal manager.

The self-management system and method can also include a communication manager as a core manager with the capability of managing email, fax and voicemail. These core communications functionalities could then also be accessible from a peripheral manager.

The self-management system can include an advisor that sends users to the best program in the suite to optimize their experience.

The scheduling manager can include a calendar. It can show milestones, schedule appointments, show to-dos, and filter the items shown. It can also show financial items and diet items, and medical items, and contact follow up items. It can be implemented as control that can be plugged into from other programs. It can have a footer for items scheduled for the day, such as milestones and long term goals. It can be structured to allow data to be uploaded to the web so that information can be available remotely. It can include a graph of history to depict how well the user is spending his or her time.

The self-management system can include an attitude manager as part of the ideology/philosophy manager. This attitude manager can be based on the principles of cognitive therapy in which the user completes numerous cognitive therapy exercises electronically. The system can categorize exercises according to the disorder they focus on. The system can link to exercises from appropriate places in other exercises. The system can track and graph exercise results. The system can uncover patterns in automatic thoughts. The system can build list of core beliefs, track and graph strength of each. The system can relate automatic thought history to core beliefs. There can be a counselor version that maintains notes on patient and accepts uploads from a patient version. The system can set therapy goals using a goal manager link. The system can schedule appointments with therapist using a scheduling manager link. The system can schedule assigned exercises to complete using links to both a goal manager and a scheduling manager.

The peripheral managers can include a diet manager that makes it easy to track and plan the user's diet. This can include an updatable, appendable database, containing nutritional information on hundreds of foods. This information can include vitamins and minerals, fat, carbohydrates, protein, and other commonly tracked values. The system can allow the user to pick from this list of foods to create a log of foods eaten as well as to create a plan for future meals. The system can include the ability for the food list to be filtered, searched, and sorted by food name, a particular nutritional value, or food category. The system can be structured to allow users to add new foods to list. The food list can contain buttons allowing user to buy the food online. The system can include a feature that allows a user to add a food to his or her log or plan by clicking on it. Food entries in the database can contain recipe info. The system can include the capability for users to assign foods to multiple categories they create. The system can tie meal plans with the calendar.

The system can include a diet advisor as a peripheral manager. This diet advisor can be used to rate diet quality according to predefined algorithms. The diet advisor can recommend food selections. The diet advisor can warn of diet deficiencies and excesses. The diet advisor can set diet goals through a link to the goal manager.

The system can include an exercise manager. This exercise manager can include an exercise selector which can show videos and/or pictures for each exercise. There can be a hierarchical list that subsumes variations under basic exercises. It can include a feature that allows the user to click on an image map of the body to see exercise list for that muscle. This image can be rotatable and zoomable. The system can allow the user to select from different set and rep schemes. The system can make recommendations on workouts. The system can track progress on workouts. The system can allow the user to input before and after pictures. The system can provide a place for the user to log his or her measurements, which can further be graphed over time. The system and tie to the goal manager to set and track exercise goals. The system can tie to the scheduling manager to manage a workout schedule.

The system can include a medical manager that can organize information on doctors, medical history, and insurance policies. This information can be saved in the core relations manager part of the suite. The system can include the capability to analyze gaps in insurance coverage. The medical manager can be designed to link to online medical information sites like WebMD. The medical manager can be integrated with phone or web based medical advice services. The medical manager can be designed to allow the user to keep an itemized list of medical conditions and links to action plans for treatment of each condition. Each medical condition can be connected to a goal in the goal manager and each action item can be a sub to-do for that goal.

The system can include a financial manager. This financial manager can provide personal accounting functionality such as checkbook balancing and expense categorization. The financial manager can include modules to educate users on core financial management practices. The financial manager can have a link to the goal manager to help set and manage financial goals. The financial manager can include the ability to accept task assignments from a financial advisor.

The system can include a legal manager that can create and store legal documents such as bills of sale, powers of attorney. This legal manager can advise on what documents the user needs for particular tasks. The legal advisor can include the ability to graph liabilities and exposure.

The system can include a career manager. This career manager can include a database of networking events. The career manager can include links to career sites. The career manager can be integrated with the contacts manager. The career manager can provide tools to help make career decisions.

The system can include an education manager. The education manager can include tools to help users choose an education path, choose schools, get accepted, and get financed.

The system can include a relationship manager. The relationship manager can include:
Tips of the day;
A map of responsibilities of each partner in the relationship, such as who is in charge of finance, who is in charge of housekeeping, etc;
Personality trait matching; and
Dating resources

While the principles of the invention have been described above in connections with specific apparatuses and methods, it is to be clearly understood that this description is made only by way of example and not as limitation on the scope of the invention.

What is claimed is:

1. A self-management system for organizing key aspects of one's life comprising:
a core manager configured to access a central pool of data that relate to common aspects of life;
a peripheral manager configured to interrelate with the core manager and help an individual focus on one detailed area of life; and
wherein data entered into the core manager is available for viewing while a user is operating the peripheral manager; and vice-versa.

2. The system of claim 1 wherein said central pool of data comprises at least one of the group of personal goals, to-do items, email, schedule, contacts, attitude, and emotions.

3. The system of claim 2 wherein said detailed area of life includes at least one area from the group of personal finance, health, career, relationships, and hobbies.

4. The system of claim 3 wherein said detailed area of life includes at least two areas from the group comprising personal finance, health, career, relationships, and hobbies.

5. A self-management method for organizing key aspects of one's life comprising the steps of:
storing information commonly used in a user's life using a core manager program;
storing information related to a detailed area of a user's life using a peripheral manager program;
providing access to the commonly-used information directly from said peripheral manager program.

6. The method of claim 5 wherein storing commonly-used information further comprises at least one from the group of personal goals, to-do items, email, schedule, contacts, attitude, and emotions.

7. The method of claim 6 wherein storing detailed information further comprises at least one from the group of personal finance, health, career, relationships, and hobbies.

8. The method of claim 7 wherein storing detailed information further comprises at least two from the group of personal finance, health, career, relationships, and hobbies.

9. A computer executing information processing code for organizing key aspects of one's life, the code comprising:
core code for managing a central pool of data that relate to common aspects of life;
peripheral code for managing data that relate to one detailed area of life;
at least one link in said core code to facilitate moving to said peripheral code;
code that allows a user to access said central pool of data from within said peripheral code.

10. The computer of claim 9 wherein said central pool of data comprises at least one of the group of personal goals, to-do items, email, schedule, contacts, attitude, and emotions.

11. The computer of claim 10 wherein said peripheral code manages data from the group of personal finance, health, career, relationships, and hobbies.
